(19) United States
(12) Patent Application Publication
(10) Pub. No.: US 2006/0151980 A1
(43) Pub. Date: Jul. 13, 2006

(54) Gas bag for a vehicle occupant restraint device

(75) Inventor: Thomas Britz, Bessenbach (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/319,326

(22) Filed: Dec. 28, 2005

(30) Foreign Application Priority Data
Jan. 11, 2005 (DE) 20 2005 000 356.5

(51) Int. Cl. B60R 21/23; B60R 21/01

(52) U.S. Cl. 280/743.1; 280/735

(57) ABSTRACT

A gas bag for a vehicle occupant restraint device includes a gas bag wall (16). The gas bag (12) has a fabric (26) with fibres which are coated with a material having piezoelectric characteristics.

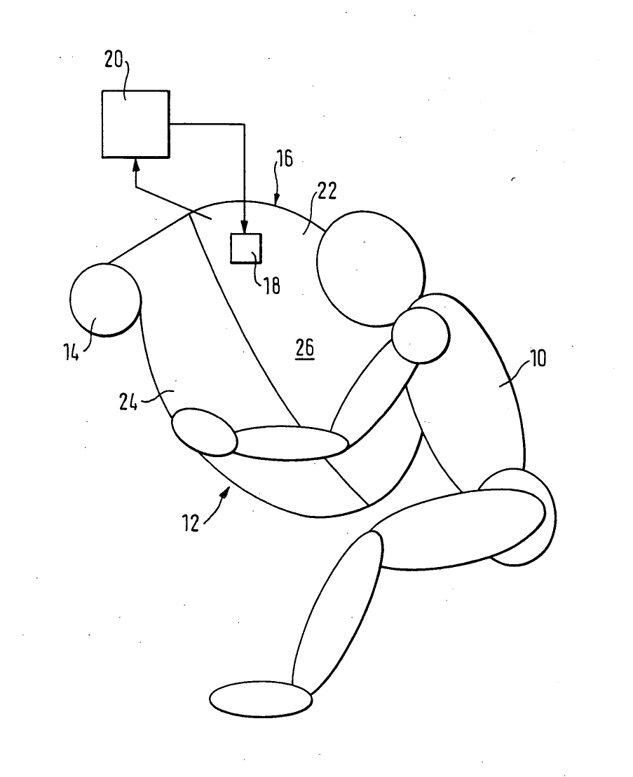

### TECHNICAL FIELD

The invention relates to a gas bag for a vehicle occupant restraint device. The invention further relates to a vehicle occupant restraint device comprising a gas bag.

### BACKGROUND OF THE INVENTION

In a gas bag with a discharge opening, it is desirable that the discharge opening remains closed, as far as possible, during the inflation process, so that the amount of gas necessary to completely fill the gas bag can be kept as small as possible. It is, furthermore, desirable to adapt the hardness of the gas bag to the respective case of stress, taking into account the physical size and the weight of the vehicle occupant. This can be achieved, as is known, by the discharge opening being opened depending on the internal pressure of the gas bag.

Gas bags are known in which a discharge opening can be opened by an active arrangement through the destruction of predetermined sections of the gas bag. For example, UK Patent Application 2 306 409 A shows a gas bag on which a pyrotechnic charge is arranged. The pyrotechnic charge can be ignited by means of an electric lead.

It is an object of the invention to provide a gas bag which, in the case of stress, makes it possible to reliably pick up the forces which are acting on the gas bag.

### BRIEF SUMMARY OF THE INVENTION

According to the invention, a gas bag for a vehicle occupant restraint device includes a gas bag wall. The gas bag has a fabric with fibres which are coated with a material having piezoelectric characteristics. Such fibres were developed and introduced for example by the Swiss Federal Material Testing and Research Institute (Eidgenössische Materialprüfungs- und Forschungsanstalt) together with other companies (see http://www.empa.ch/plugin/template/empa/225/21999/---/1=1). Using the gas bag according to the invention, information can be obtained concerning the actual stress of the gas bag by the coated fibres, which serve as sensors. The mechanical forces which act on the fibres when the vehicle occupant plunges into the inflated gas bag are converted into electrical signals by the piezoelectric material coating. The electrical signals which are representative of the load on the gas bag can then be utilized for various purposes. In particular, an active opening of discharge openings in the gas bag or in other components of the gas bag module, in which the gas bag is housed, can be performed as a function of the electrical signals.

The gas bag wall of the gas bag according to the invention can be formed substantially entirely or only partially from the fabric. In the latter, more favourably priced case, in particular a fabric section of a known gas bag design, which receives a representative proportion of the force of the impinging vehicle occupant, can be replaced by the fabric with the coated fibres.

According to an alternative embodiment, the fabric is fastened to the gas bag wall. In this case, the gas bag wall can consist entirely of conventional material. The fabric with the coated fibres is subsequently applied.

The invention also provides a vehicle occupant restraint device with a gas bag according to the invention. The occupant restraint device further includes an electronic control for detecting and evaluating the electrical signals of the fabric.

According to a preferred embodiment of the invention, the gas bag has an electrically controllable arrangement provided on the gas bag wall, in particular an arrangement with which, under particular circumstances, a discharge opening in the gas bag can be opened at a defined moment.

The preferred embodiment in addition makes provision that the electronic control controls the electrically controllable arrangement as a function of the signals picked up from the material having piezoelectric characteristics. This can take place, for example, in that the electronic control causes the opening of a discharge opening when a given threshold value is exceeded. With a finer evaluation of the electrical signals it is also possible to regulate the effective cross-section of a discharge opening as a function of the signals.

### BRIEF DESCRIPTION OF THE DRAWINGS

In the drawing, the single FIGURE diagrammatically shows a gas bag module according to the invention, with an unfolded gas bag in the case of stress.

### DETAILED DESCRIPTION OF THE PREFERRED EMBODIMENTS

In the FIGURE, a vehicle occupant 10 is illustrated, who is plunging into an inflated gas bag 12 of a vehicle occupant restraint device according to the invention. The gas bag 12, which has unfolded from a gas bag module 14, has a gas bag wall 16 on which an electrically controllable arrangement 18 is provided. The arrangement 18 serves to selectively open a discharge opening through which gas can escape from the gas bag 12. The arrangement 18 is connected with an electronic control 20, by which the arrangement 18 is controlled.

The gas bag 12 has a front fabric piece 22, which faces the vehicle occupant 10 in the inflated state of the gas bag 12, and a rear fabric piece 24. The gas bag 12 comprises a fabric 26 with fibres which are coated with a nanocrystalline piezoceramic material. This material has the characteristic of generating electrical signals (piezo voltage) as a function of the mechanical action of force. The fabric 26 with the coated fibres is connected with the electronic control 20 in a suitable manner.

The gas bag 12 can consist substantially entirely of the fabric 26 with the coated fibres. However, provision may also be made to only form a particular fabric piece of the gas bag 12 from the fabric 26 with the coated fibres, in particular the fabric piece 22 facing the vehicle occupant 10 and directly receiving the force of the impinging vehicle occupant 10. Finally, it is also possible to apply the fabric 26 externally or internally onto a part of the gas bag wall 16, e.g. the fabric piece 22.

In the case of a load on the inflated gas bag 12, as occurs on immersion of the vehicle occupant 10, the fabric 26 generates a piezo voltage due to the piezoceramic coating, the extent of which voltage depends on the action of force onto the fabric 26. The piezo voltage is picked up and evaluated by the electronic control 20. If the piezo voltage exceeds a given threshold value, the electrically controllable arrangement 18 is activated and a discharge opening of the gas bag 12 (or of another component of the gas bag module 14) is opened to reduce the internal pressure of the gas bag.

According to a more sophisticated application of the invention, the electrically controllable arrangement 18 is able to vary the effective cross-section of a discharge opening of the gas bag 12 (or of another component of the gas bag module 14). In this case, the arrangement 18 is controlled by the electronic control 20 such that the effective cross-section of the discharge opening is set to a value which is dependent on the picked up piezo voltage. Thus, the internal pressure of the gas bag 12 can be regulated depending on stress, in the desired manner.

1. A gas bag for a vehicle occupant restraint device, the gas bag including a gas bag wall, the gas bag having a fabric with fibres which are coated with a material having piezoelectric characteristics.

2. The gas bag according to claim 1, wherein the gas bag wall is formed substantially entirely from the fabric.

3. The gas bag according to claim 1, wherein the gas bag wall is partially formed from the fabric.

4. The gas bag according to claim 1, wherein the fabric is fastened to the gas bag wall.

5. A vehicle occupant restraint device comprising a gas bag, the gas bag including a gas bag wall and having a fabric with fibres, the fibres being coated with a material having piezoelectric characteristics, the vehicle occupant restraint system further including an electronic control for picking up and evaluating the electrical signals of the fabric.

6. The vehicle occupant restraint device according to claim 5, wherein the gas bag has an electrically controllable arrangement provided on the gas bag wall.

7. The vehicle occupant restraint device according to claim 6, wherein the electronic control controls the electrically controllable arrangement as a function of the signals picked up from the material having piezoelectric characteristics.
